(19) United States
(12) Patent Application Publication
(10) Pub. No.: US 2026/0368881 A1
(43) Pub. Date: Nov. 19, 2026

(54) METHOD AND SYSTEM FOR DETECTING SUSPECTED DEFECT AREAS

(71) Applicant: LG MANAGEMENT DEVELOPMENT INSTITUTE CO., LTD., Seoul (KR)

(72) Inventors: Run CUI, Seoul (KR); Seung Hwan Kim, Seongnam-si (KR); Jee Ho Hyun, Seoul (KR); Gi Young Jeon, Seoul (KR); Byung Jun Kang, Yongin-si (KR); Sang Yun Kim, Gimpo-si (KR); Young San Koh, Seoul (KR)

(21) Appl. No.: 19/734,672

(22) Filed: Jul. 8, 2026

Related U.S. Application Data
(63) Continuation of application No. PCT/KR2025/014499, filed on Sep. 18, 2025.

(30) Foreign Application Priority Data
Sep. 27, 2024 (KR) 10-2024-0132130

(51) Int. Cl. G06T 7/00; G06T 7/33; G06T 7/66; G06V 10/26; G06V 10/74; G06V 10/764; G06V 10/82

(52) U.S. Cl. CPC G06T 7/001; G06T 7/337; G06T 7/66; G06T 2207/20021; G06T 2207/20076; G06T 2207/20081; G06T 2207/20084; G06V 10/26; G06V 10/761; G06V 10/764; G06V 10/82; G06V 2201/06

(57) ABSTRACT

A method for detecting a suspected defective area by a computing system including a memory and a processor according to an embodiment of the present disclosure includes: obtaining N (N>1) good product images; obtaining an inspection target image which is a captured image of a target to be determined to be defective; aligning the inspection target image based on the good product image; dividing the aligned inspection target image into patch units; obtaining multi-scale features based on the divided patches by using a predetermined Pre-trained model; estimating the patch-specific good product probability based on the obtained multi-scale features; determining whether the inspection target image is suspected to be defective based on the estimated patch-specific good product probability; and providing the determination result of whether the inspection target image being suspected to be defective.

### CROSS REFERENCE TO RELATED APPLICATION

This application is a Bypass Continuation of International Patent Application No. PCT/KR2025/014499, filed on Sep. 18, 2025, which claims priority from and the benefit of Korean Patent Application No. 10-2024-0132130, filed on Sep. 27, 2024, which is hereby incorporated by reference for all purposes as if fully set forth herein.

### BACKGROUND

### Field

Embodiments of the invention relate generally to a suspected defective area detection method and a system thereof, and more particularly, the present disclosure relates to a vision inspection method and a system thereof which detect a suspected defective area through a deep learning-based Pre-trained model without separate training by using a small number of good product images.

### Discussion of the Background

In general, vision inspection equipment aims to automatically detect defects present on the appearance of products using computer vision technologies including deep learning.

Based on data obtained through sensor equipment such as cameras, good products and defective products containing defects must be classified with very high accuracy, and for product quality control, the equipment in an inspection process must operate uniformly without problems.

At this time, since a processing time in the inspection process affects product production volume, it is also very important to process quickly with high accuracy.

However, since most vision inspections are captured at high resolution to detect even minute defects, using a deep learning model to perform detailed inspection of an entire product region can achieve high accuracy but has limitations in terms of the processing time.

Thus, in the conventional art in this technical field, efforts are being made to satisfy accuracy and processing time by using a rule-based algorithm using prior knowledge to detect a suspected defective area and determining through the deep learning model in post-processing.

However, the rule-based algorithm using various image processing and image-based quantitative measurements has disadvantages in that performance is determined by a developer's capabilities and know-how, and when there is a change in an inspection environment, it is difficult to readjust rules and much cost and time are incurred.

For example, considering that when a scratch occurs on a product appearance, it is characterized in that the product is reflected by illumination and has a high brightness value, there is a rule-based algorithm that performs image processing to binarize a region where a scratch has occurred when the brightness value is equal to or greater than a specific value based on the brightness value, defines the corresponding region through Connected Component Labeling, measures the size thereof, and detects the corresponding region as a defective area, if an intensity of the illumination weakens or a material of the product changes such that reflection from the illumination increases, the performance of this rule-based algorithm for defining a scratch region is inevitably degraded.

Therefore, development and introduction of new technologies to solve the above problems are necessary.

The above information disclosed in this Background section is only for understanding of the background of the inventive concepts, and, therefore, it may contain information that does not constitute prior art.

### SUMMARY

An embodiment of the present disclosure is contrived to solve the problems of the prior art as described above, and is to provide a vision inspection method and a system thereof which detect a suspected defective area through a deep learning-based Pre-trained model without separate training by using a small number of good product images.

However, a technical object to be achieved by the present disclosure and an embodiment of the present disclosure is not limited to the technical objects and there may be other technical objects.

Additional features of the inventive concepts will be set forth in the description which follows, and in part will be apparent from the description, or may be learned by practice of the inventive concepts.

According to an embodiment of the present disclosure, a method executed by a computer includes: loading, by at least one processor, at least one image, the at least one image including N good product images, where N>1, and at least one inspection target image including a captured image of a target to be evaluated for a defect; aligning, by the at least one processor, the at least one inspection target image based on the loaded N good product images; dividing, by the at least one processor, the aligned at least one inspection target image into at least one patch unit; ingesting, by the at least one processor, the at least one divided patch unit into at least one artificial intelligence model and obtaining multi-scale features based on the divided patch units, wherein the artificial intelligence model includes a deep learning model pre-trained on a large-scale image data set; estimating, by the at least one processor, the patch-specific good product probability based on the obtained multi-scale features; determining, by the at least one processor, whether the inspection target image is suspected to be defective based on the estimated patch-specific good product probability; and manifesting, by the at least one processor, a determination result indicating whether the inspection target image is suspected to be defective through at least one interface.

In an embodiment, the multi-scale features may include data extracted from a feature vector for a predetermined image based on various sizes or resolutions.

In an embodiment, the obtaining of the multi-scale features may include generating the size in the patch unit and obtaining the multi-scale features.

In an embodiment, the estimating of the patch-specific good product probability may include calculating a similarity between a feature vector of each of the patches and a feature vector of a good product image based on Gaussian density estimation.

In an embodiment, the calculating of the similarity may include calculating a mean and a covariance of the feature vectors of the good product image, and calculating the similarity based on the calculated mean and covariance, and the feature vector of each of the patches.

In an embodiment, the determining of whether the inspection target image is suspected to be defective may include comparing each of the patch-specific good product probabilities with a predetermined first threshold, and determining each patch as a good product patch or a suspected defective patch based on a result of the comparison.

In another embodiment, the determining of whether the inspection target image is suspected to be defective may include comparing each of the patch-specific good product probabilities with a predetermined second threshold, determining a patch having a good product probability equal to or greater than the second threshold as the good product patch, and comparing a good product probability which is smaller than the second threshold with a predetermined third threshold, and determining a patch having a good product probability equal to or smaller than the third threshold as a suspected defective patch.

In an embodiment, the determining of whether the inspection target image is suspected to be defective may further include obtaining a plurality of sub-patches based on a patch having a good product probability which is smaller than the second threshold and greater than the third threshold, calculating a minimum good product probability value corresponding to a lowest good product probability among the good product probabilities of the plurality of sub-patches, extracting an area having a predetermined size based on an area matching the obtained minimum good product probability value, and determining whether the inspection target image is suspected to be defective based on an image including the extracted area.

In an embodiment, the determining of whether the inspection target image is suspected to be defective may further include, in response to a plurality of minimum good product probability values being present, calculating a center of gravity corresponding to positions of areas associated with the plurality of minimum good product probability values, extracting an area having a predetermined size based on an area corresponding to the calculated center of gravity, and determining whether the inspection target image is suspected to be defective based on an image including the extracted area.

In an embodiment, the determining of whether the inspection target image is suspected to be defective may further include comparing each of the patch-specific good product probabilities with at least one predetermined threshold, classifying each patch as a good product patch or a suspected defective patch based on a result of the comparison, and determining whether the inspection target image is suspected to be defective based on the number of patches classified as at least one of the good product patch or the suspected defective patch.

In an embodiment, the aligning of the inspection target image based on the good product image includes selecting any one of the N good product images, where N>1, as a good product representative image, detecting features of each of the good product representative image and the inspection target image, matching corresponding features between the features detected from the good-product representative image and the inspection target image, estimating a homography matrix based on the matched features, and performing image warping on the inspection target image based on the estimated homography matrix.

According to another embodiment of the present disclosure, a system includes: at least one memory; and at least one processor configured to read at least one application stored in the at least one memory and to detect a suspected defective area, in which the at least one processor is configured to execute instructions that cause the system to perform: loading, by the at least one processor, at least one image stored in the at least one memory, wherein the at least one image includes N good product images, where N>1, and at least one inspection target image which is a captured image of a target to be evaluated for a defect; aligning, by the at least one processor, the inspection target image based on the loaded good product image; dividing, by the at least one processor, the aligned inspection target image into at least one patch unit; inputting, by the at least one processor, the at least one divided patch unit into at least one artificial intelligence model, and obtaining multi-scale features based on the divided patch units, the artificial intelligence model including a deep learning model pre-trained on a large-scale image data set; estimating, by the at least one processor, a patch-specific good product probability based on the obtained multi-scale features; determining, by the at least one processor, whether the inspection target image is suspected to be defective based on the estimated patch-specific good product probability; and outputting, by the at least one processor, a result indicating whether the inspection target image is suspected to be defective through at least one interface.

According to another embodiment of the present disclosure, a system includes: at least one memory; and at least one processor configured to execute instructions stored in the at least one memory, in which the instructions, when executed, cause the at least one processor to: obtain a plurality of good product images and an inspection target image; perform alignment of the inspection target image with respect to at least one of the good product images; partition the aligned inspection target image into a plurality of regions; process the regions using an artificial intelligence model to generate feature information for the regions; derive, for each region, a probability value indicative of whether the region corresponds to a good product region; evaluate the inspection target image for a potential defect based on the probability values; and output information indicating whether the inspection target image is suspected to be defective.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a schematic example of a block diagram of a computing system implementing a suspected defective area detection service according to an embodiment of the present disclosure.

FIG. 2 is a schematic example of a block diagram of a computing device implementing a suspected defective area detection service according to an embodiment of the present disclosure.

FIG. 3 is a schematic example of a block diagram from another aspect of a computing device implementing a suspected defective area detection service according to an embodiment of the present disclosure.

FIG. 4 is a schematic flowchart for describing a suspected defective area detection method according to an embodiment of the present disclosure.

FIG. 5 is a schematic conceptual view for describing a method for aligning an inspection target image according to an embodiment of the present disclosure.

FIG. 6 schematically illustrates examples for describing an image division method in patch units according to an embodiment of the present disclosure.

FIG. 7 is a schematic conceptual view for describing a method for extracting image features through a Pre-trained model according to an embodiment of the present disclosure.

FIG. 8 illustrates a conceptual view for describing a method for obtaining multi-scale features according to an embodiment of the present disclosure.

FIG. 9 is a schematic flowchart for describing a multi-stage classification method for patch images for each good product probability according to an embodiment of the present disclosure.

FIG. 10 is a schematic example of a diagram for describing a method for obtaining a minimum good product probability section image according to an embodiment of the present disclosure.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

The present disclosure may have various modifications and various embodiments and specific embodiments will be illustrated in the drawings and described in detail in the detailed description. Effects and features of the present disclosure, and methods for accomplishing the same will be more clearly understood from embodiments described in detail below with reference to the accompanying drawings. However, the present disclosure is not limited to embodiments disclosed below but may be implemented in various forms. In the following embodiment, the terms such as first, second, etc., are not restrictive meanings but are used for distinguishing one component from other components. Further, a singular form may include a plural form if there is no clearly opposite meaning in the context. Further, the terms such as “include” or “have” mean that there is a feature or a component disclosed in the specification and a possibility that one or more other features or components will be added is not pre-excluded. In addition, in the drawing, for convenience of description, sizes of the components may be exaggerated or reduced. For example, each configuration illustrated in the drawings is arbitrarily shown for understanding and ease of description, but the present disclosure is not limited thereto.

Hereinafter, the embodiments of the present disclosure will be described in detail with reference to the accompanying drawings, in which like reference numerals refer to like or corresponding components and a duplicated description thereof will be omitted when the embodiments are described with reference to the drawings.

### [Example System Providing Suspected Defective Area Detection Service]

Hereinafter, an example system implementing a suspected defective area detection service detecting a suspected defective area through a deep learning-based Pre-trained model without separate training by using a small number of good product images will be described in detail with reference to the accompanying drawings.

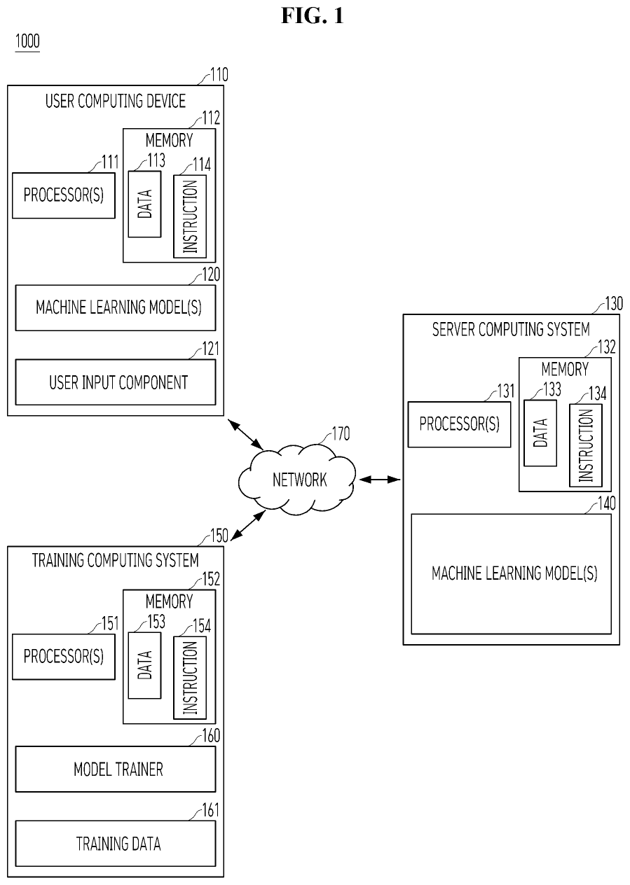

FIG. 1 illustrates an example of a block diagram of a computing system implementing a suspected defective area detection service according to an embodiment of the present disclosure.

Referring to FIG. 1, the computing system 1000 implementing the suspected defective area detection service according to the present disclosure includes a user computing device 110, a server computing system 130, and a training computing system 150, and each device and the system are communicatively connected through a network 170.

A suspected defective area detection method and a system thereof according to an embodiment of the present disclosure may 1) be implemented locally by the user computing device 110, 2) implemented and provided in the form of a web service by the server computing system 130 which communicates with the user computing device 110, and 3) implemented and provided by mutual association of the user computing device 110 and the server computing system 130.

In this case, in an embodiment, the user computing device 110 and/or the server computing system 130 may train a machine learning model 120 and/or 140 through an interaction with a training computing system 150 which is communicatively connected through the network 170. The training computing system 150 may be separated from the server computing system 130 or may be a part of the server computing system 130.

In addition, in this case, the artificial intelligence model may be 1) directly trained locally by the user computing device 110, 2) trained while the server computing system 130 and the user computing device 110 interact with each other through the network 170, and 3) trained by using various training techniques and learning techniques by the separate training computing system 150. In addition, the artificial intelligence model trained by the training computing system 150 may also be implemented by a method in which the artificial intelligence model trained by the training computing system 150 is transmitted to the user computing device 110 and/or the server computing system 130 through the network 170, and provided/updated.

In some embodiments, the training computing system 150 may be a part of the server computing system 130 or a part of the user computing device 110.

### —User Computing Device 110

The user computing device 110 may include any type of computing device, such as a smart phone, a cellular phone, a digital broadcasting device, personal digital assistants (PDA), a portable multimedia player (PMP), a desktop, a wearable device, an embedded computing device, and/or a tablet PC.

In addition, in an embodiment, the user computing device 110 may further include a predetermined server computing device that provides an environment for performing suspected-defective-area detection.

The user computing device 110 may include one or more processors 111 and memories 112.

Here, the processor 111 may include at least one of a central processing unit (CPU), a graphic processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and electric units configured to perform one or more functions, or a plurality of such processors that are electrically interconnected.

The memories 112 may include one or more non-transitory/transitory computer-readable storage media including a RAM, a ROM, an EEPROM, an EPROM, a flash memory device, a magnetic disk, etc., and combinations thereof, and may include a web storage of a server which performs a storage function of the memory on the Internet. The memories 112 may store data 113 and instructions 114 for enabling the one or more processors 111 to perform functional operations, including training an artificial intelligence model and executing a suspected suspected defective area detection process using the artificial intelligence model.

In an embodiment, the user computing device 110 may perform various deep learning for the suspected defective area detection service in conjunction with a deep learning neural network.

Here, the deep learning neural network according to the embodiment may include a convolutional neural network (CNN), Regions with CNN features (R-CNN), Fast R-CNN, Faster R-CNN, Mask R-CNN, etc., and may include any deep learning neural network containing algorithms that may perform embodiments described below, and the embodiment of the present disclosure does not limit or restrict such deep learning neural network itself.

In this case, according to the embodiment, the deep learning neural network may be installed directly in the server computing system 130 or operate as a separate device from the server computing system 130 to perform deep learning for the suspected defective area detection service.

Further, in an embodiment, the user computing device 110 may store one or more machine learning models 120.

For example, the user computing device 110 may be a variety of machine learning models, such as a plurality of neural networks (e.g., deep neural networks) that perform a suspected defective area detection method based on structured/quantitative data, or other types of machine learning models including nonlinear models and/or linear models, and may include combinations thereof.

For example, the machine learning model may store a linear regression, a crystal tree, a random forest, and a gradient boosting pre-trained language model, or/and an in-depth learning model. In addition, the neural network may include at least one of feed-forward neural networks, recurrent neural networks (e.g., long/short-term memory recurrent neural networks), convolutional neural networks, or/and other types of neural networks.

Further, according to the embodiment, the user computing device 110 may store, in order to perform at least some of processes performed for the suspected defective area detection method through a large language model (LLM), a model used in each process and a prompt template which becomes a basis of an input in the model.

In an embodiment, the user computing device 110 receives one or more machine learning models 120 from the server computing system 130 through the network 170, stores the received machine learning models 120 in the memory 112, and then executes the stored machine learning models 120 in the processor 111 to perform a suspected defective area detection process.

In another embodiment, the user computing device 110 may perform operations through a machine learning model 140 including one or more machine learning models 140 in conjunction with the server computing system 130 and may provide the suspected defective area detection service to a user by communicating data related thereto with external systems.

For example, the user computing device 110 may perform the suspected defective area detection service in a method in which the server computing system 130 provides an output to a user's input using the machine learning model 140 via the web.

Furthermore, the artificial intelligence model may be implemented in such a method that at least some of the machine learning models 120 and/or 140 are executed on the user computing device 110 and the rest are executed on the server computing system 130.

Further, the user computing device 110 may include one or more input components 121 that sense the input of the user.

For example, the user input component 121 may include a touch sensor (e.g., a touch screen and/or a touch pad) which senses a touch of an input medium (e.g., a finger or a stylus) of the user, an image sensor which senses a motion input of the user, a microphone which senses a user voice input, a button, a mouse, and/or a keyboard.

Here, the image sensor may include an image processing module. In detail, the image sensor may process a still image or a moving picture obtained by an image sensor device (e.g., CMOS or CCD).

Further, the image sensor may extract required information by processing the still image or the moving picture obtained through the image sensor device using an image recognition processor (e.g., OCR, etc.) and/or the image processing module and transfer the extracted information to the processor.

In addition, the input component 121 may, based on an interface module, receive input from an external controller (e.g., mouse, keyboard, etc.), and in such case may include an external output device (e.g., speaker).

In this case, the interface module may be configured to include at least one of a wireless/wired headset port, an external charger port, a wired/wireless data port, a memory card port, a port connecting a device with an identification module, an audio input/output (I/O) port, a video input/output (I/O) port, an earphone port, a power amplifier, an RF circuit, a transceiver, and other communication circuits.

Furthermore, the external output device may include a display system that outputs various information related to the suspected defective area detection service as a graphical image.

The display system may be implemented to include at least one of a liquid crystal display (LCD), a thin film transistor-liquid crystal display (TFT LCD), an organic light-emitting diode (OLED), a flexible display, a 3D display, and an electronic ink (e-ink) display.

Meanwhile, the user computing device 110 including the above-described components may further perform at least some of the functional operations performed by the server computing system 130 described below.

### —Server Computing System 130

The server computing system 130 may perform a series of processes for providing the suspected defective area detection service.

In detail, in an embodiment, the server computing system 130 may provide the suspected defective area detection service by exchanging data required to enable the suspected defective area detection service process to be driven on an external device such as the user computing device 110 with the external device.

In more detail, in an embodiment, the server computing system 130 may provide an environment for an application to operate on the user computing device 110.

To this end, the server computing system 130 may include an application program, data, and/or instructions for operating the application, and transmit and receive various data based on the application program, data, and/or instructions to and from the external device.

Further, the server computing system 130 may include one or more processors 131 and memories 132. Here, the processor 131 may include at least one of a central processing unit (CPU), a graphic processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and electric units for performing other functions or a plurality of processors which are electrically connected.

In addition, the memories 132 may include one or more non-transitory/transitory computer-readable storage media, such as a RAM, a ROM, an EEPROM, an EPROM, a flash memory device, a magnetic disk, etc., and combinations thereof. The memories 132 may store data 133 and instructions 134 for enabling the processor 131 to perform functional operations, including training an artificial intelligence model or executing a suspected defective area detection process using the artificial intelligence model.

In an embodiment, the server computing system 130 may be implemented using one or more computing devices. For example, the server computing system 130 may be configured so that a plurality of computing devices operate according to sequential computing architecture, parallel computing architecture, or a combination thereof. Further, the server computing system 130 may include a plurality of computing devices connected through the network 170.

Further, the server computing device 130 may store one or more machine learning models 140. For example, the server computing system 130 may include a neural network and/or other multi-layer non-linear models as the machine learning model 140. Examples of neural networks may include a feed-forward neural network, a deep neural network, a recurrent neural network, or a convolutional neural network.

In an embodiment, the server computing system 130 may further include a data store computing system (hereinafter, referred to as a data store) which is a storage for continuously storing and managing raw data which is a basis of the suspected defective area detection service.

The data store may include various types of data storage systems, including a file system and a cloud storage system. For example, the data store may include at least one database such as a relational database using a structured query language (SQL) for defining and manipulating data, an NoSQL database designed to provide flexibility and scalability for processing non-formal and semi-formal data, or a data warehouse configured for reporting and data analysis, which is optimized for query and analysis by centralizing mass data of various sources, a data warehouse storing mass raw data as structuralized data, semi-structuralized data, and non-structuralized data which are basic formats, a local storage device storing data in a file in a format which may generally access a computer operating system, or a network attached storage (NAS).

### —Training Computing System 150

The training computing system 150 may include one or more processors 151 and memories 152. Here, the processor 151 may include at least one of a central processing unit (CPU), a graphic processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and electric units for performing other functions or a plurality of processors which are electrically connected.

In addition, the memories 152 may include one or more non-transitory/transitory computer-readable storage media including a RAM, a ROM, an EEPROM, an EPROM, a flash memory device, a magnetic disk, etc., and combinations thereof. The memories 152 may store data 153 and instructions 154 required for the processor 151 to perform training of the artificial intelligence model, etc.

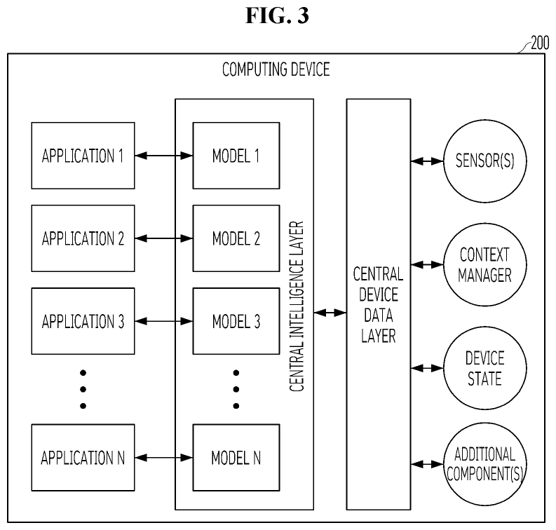

For example, the training computing system 150 may include a model trainer 160 which trains the machine learning models 120 and/or 140 stored in the user computing device 110 and/or the server computing system 130 by using various training or learning techniques such as backpropagation of an error (according to a framework illustrated in FIG. 3).

For example, the model trainer 160 may perform updating one or more parameters of the machine learning models 120 and/or 140 for the suspected defective area detection service based on a defined loss function by a backpropagation scheme.

In some implementation examples, performing the backpropagation of the error may include performing truncated backpropagation through time. The model trainer 160 may perform multiple generalization techniques (e.g., weight reduction, drop-out, and/or knowledge distillation) in order to enhance a generalization capability of the trained machine learning models 120 and/or 140.

Further, the model trainer 160 may train the machine learning models 120 and/or 140 based on a series of training data 161. Here, the training data 161 may include, for example, different formats of data such as an image, an audio sample, and/or text. Examples of image types which may be used may include a video frame, LiDAR point cloud, an X-ray image, a computer tomography scan, a hyperspectral image, and/or various other types of images.

The training data 161 may be provided by the user computing device 110 and/or the server computing system 130. When the training computing device trains the machine learning models 120 and/or 140 with respect to specific data of the user computing device 110, the machine learning models 120 and/or 140 may be characterized as a personalized model.

In addition, the model trainer 160 includes a computer logic utilized to provide a desired function.

Further, the model trainer 160 may be implemented as hardware, firmware, and/or software controlling a general-purpose processor. In one implementation example, the model trainer 160 may include a program file stored in a storage device, and may be loaded to the memory 152 and executed by one or more processors 151. In another implementation example, the model trainer 160 includes one or more sets of computer-executable data 153 and instructions 154 stored in executable by a tangible computer-readable storage medium such as a RAM hard disk or an optical or magnetic medium.

The network 170 includes a 3rd Generation Partnership Project (3GPP) network, a Long Term Evolution (LTE) network, a World Interoperability for Microwave Access (WIMAX) network, Internet, a Local Area Network (LAN), Wireless Local Area Network (LAN), a Wide Area Network (WAN), a Personal Area Network (PAN), a Bluetooth network, a satellite broadcasting network, an analog broadcasting network, and/or a Digital Multimedia Broadcasting (DMB) network, etc., but is not limited thereto.

In general, communication through the network 170 may be performed through various communication protocols (e.g., TCP/IP, HTTP, SMTP, and/or FTP, etc.), encoding or formats (e.g., HTML and/or XML, etc.), and/or protective schemas (e.g., VPN, secure HTTP, and/or SSL, etc.) by using uses any type of wired and/or wireless connection.

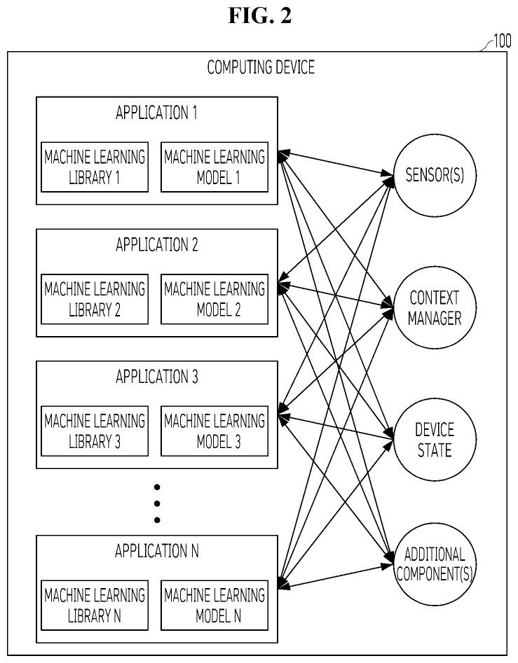

FIG. 2 illustrates an example of a block diagram of a computing device implementing a suspected defective area detection service according to an embodiment of the present disclosure.

Referring to FIG. 2, the computing device 100 included in the user computing device 110, the server computing system 130, and the training computing system 150 may include multiple applications (e.g., applications 1 to N). Each application may include a machine learning library and one or more machine learning models. For example, the application may include an image processing (e.g., detection, classification, and/or segmentation) application, a text messaging application, an e-mail application, a dictation application, a virtual keyboard application, a browser application, and/or a chat-bot application.

In an embodiment, the computing device 100 may include the model trainer 160 for training the artificial intelligence model, and stores and operates the trained artificial intelligence model to provide output data according to predetermined input data (in an embodiment, an inspection target image, etc.).

Each application of the computing device 100 may communicate with various components of the computing device 100, such as one or more sensors, context managers, device-state components, and other system components. In an embodiment, each application may communicate with the respective device component through an application programming interface (API), such as a public API). In another embodiment, the API used by each application may be specific for the corresponding application.

FIG. 3 illustrates an example of a block diagram from another aspect of a computing device implementing a suspected defective area detection service according to an embodiment of the present disclosure.

Referring to FIG. 3, the computing device 200 may include multiple applications (e.g., applications 1 to N). Each application may communicate with a central intelligence layer. For example, the applications may include an image processing application, a text message application, an email application, a dictation application, a virtual keyboard application, and/or a browser application. In an embodiment, each application may communicate with the central intelligence layer, and a model stored therein, through an application programming interface (API), such as a common API for all applications.

The central intelligence layer may include multiple machine learning models. For example, as illustrated in FIG. 3, at least some of the respective machine learning models may be provided individually for respective applications and managed by the central intelligence layer. In another implementation example, two or more applications may share a single machine learning model. For example, in some examples, the central intelligence layer may provide a single model for all applications. In some examples, the central intelligence layer may be incorporated into an operating system of the computing device 200, or may be implemented separately from the operating system.

The central intelligence layer may communicate with a central device data layer. The central device data layer may be a centralized data storage for the computing device 200. As illustrated in FIG. 3, the central device data layer may communicate with multiple other components of the computing device 200, such as one or more sensors, context managers, device state components, and/or additional components, for example. In some implementation examples, the central device data layer may communicate with each device component by using an API (e.g., a private API).

The techniques describe in the present disclosure may involve information transmitted from the servers, databases, software applications and other computer-based systems, as well as the taken action and the information transmitted to the system or transmitted from the system. An intrinsic flexibility of the computer-based systems will perceive that extensive possible components, combinations, division of combinations and tasks and a functionality between components and from the components are permitted. For example, the processes described in this specification may be implemented by using a single device or component or multiple devices or components which operate as combinations. Databases and applications may be implemented in a single system or systems distributed over multiple systems. The distributed components may operate in sequence or in parallel.

### [Method for Providing Suspected Defective Area Detection Service]

Hereinafter, a method in which a computing system 1000 according to an embodiment of the present disclosure implements a suspected defective area detection service will be described in detail with reference to the accompanying drawings. In this embodiment, the computing system may detect a suspected defective area using a deep learning-based pre-trained model, without requiring separate training, by utilizing only a small number of good product images.

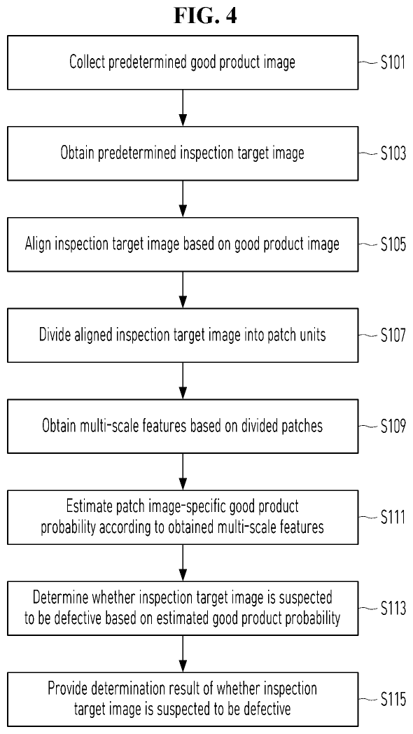

FIG. 4 illustrates a flowchart for describing a suspected defective area detection method according to an embodiment of the present disclosure.

Referring to FIG. 4, a method for providing a suspected defective area detection service according to an embodiment of the present disclosure may include: collecting a predetermined good product image (S101); obtaining a predetermined inspection target image (S103); aligning the inspection target image based on the good product image (S105); dividing the aligned inspection target image into patch units (S107); a step of obtaining multi-scale features based on the divided patches (S109); estimating a good product probability for each patch image according to the obtained multi-scale features (S111); determining whether the inspection target image is suspected to be defective based on the estimated good product probability (S113); and providing a suspected defect determination result (S115).

In detail, the computing system 1000 according to an embodiment of the present disclosure may collect a predetermined good product image (S101).

Here, the good product image according to the embodiment may mean an image captured of a product having an excellent quality and no defect.

In detail, in an embodiment, the computing system 1000 may obtain and collect N good product images, where N>1, in conjunction with a predetermined sensor system and/or an external device.

Further, the computing system 1000 according to an embodiment of the present disclosure may obtain a predetermined inspection target image (S103).

Here, the inspection target image according to the embodiment may mean an image of a target (product) to be determined for the presence or absence of a defect.

In detail, in an embodiment, the computing system 1000 may obtain the above-described inspection target image in conjunction with a predetermined sensor system (e.g., a digital camera, etc.) and/or an external device (e.g., vision inspection equipment, etc.).

Further, the computing system 1000 according to an embodiment of the present disclosure may align the inspection target image based on the good product image (S105).

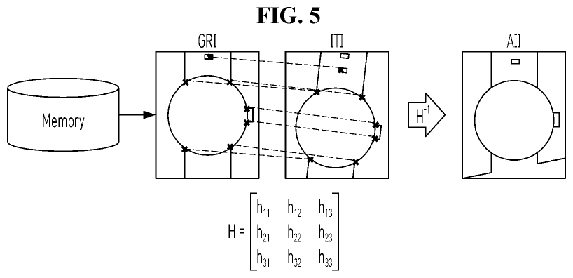

FIG. 5 illustrates a conceptual view for describing a method for aligning an inspection target image according to an embodiment of the present disclosure.

In detail, referring to FIG. 5, in an embodiment, the computing system 1000 may select any one of the N good product images as a good product representative image GRI according to a predetermined method, such as user input and/or a pre-built image selection algorithm.

In this case, in an embodiment, the computing system 1000 may store the selected good product representative image GRI in the non-volatile memory and use the stored good product representative image GRI for image alignment described below.

Further, in an embodiment, the computing system 1000 may align a position of an inspection target image ITI based on the good product representative image GRI.

This may be performed to prevent performance degradation caused by a positioning error that occurs when a target product is not consistently captured at the same position during acquisition of the inspection target image ITI.

In an embodiment, the computing system 1000 may calculate a homography matrix based on the good product representative image GRI and the inspection target image ITI.

For reference, a homography may be represented as a matrix that expresses a geometric transformation between two images in a two-dimensional plane, and may be used to map a feature point of one image to a corresponding point of another image. Through such a transformation, two images may be aligned to lie on the same plane even when the two images are captured from different viewpoints.

In detail, in an embodiment, the computing system 1000 may detect features of each of the good product representative image GRI and the inspection target image ITI.

In more detail, the computing system 1000 may detect the feature of the good product representative image GRI (hereinafter, referred to as good product feature) and the feature of the inspection target image ITI (hereinafter, referred to as target feature) by using a predetermined feature extraction algorithm (e.g., algorithms such as Scale-Invariant Feature Transform (SIFT), Speeded-Up Robust Features (SURF), Oriented FAST and Rotated BRIEF (ORB), FAST9, SuperPoint, Munkres, and/or LightGlue.

Further, in an embodiment, the computing system 1000 may perform matching between the detected features.

In detail, the computing system 1000 may detect mutually corresponding features between the good product feature and the target feature by using a predetermined feature matching algorithm (e.g., Brute-Force Matching and/or FLANN Fast Library for Approximate Nearest Neighbors).

In addition, the computing system 1000 may match the detected features with each other to form one pair.

In particular, the computing system 1000 may obtain a plurality of feature pairs (hereinafter, corresponding point pairs) that mutually match features at most approximate positions between the good product feature and the target feature.

In this case, according to the embodiment, the computing system 1000 may remove a feature pair (hereinafter, referred to as an anomaly pair) having a matching rate equal to or smaller than a predetermined reference value among the plurality of feature pairs by using a predetermined anomaly removal algorithm (e.g., Random Sample Consensus (RANSAC), etc.).

For reference, the RANSAC may be a homography matrix estimation method that iteratively calculates the homography using a predetermined feature pair and minimizes errors for all feature pairs.

In particular, the computing system 1000 may perform filtering to remove noise components within the plurality of feature pairs using the anomaly removal algorithm such as such as the RANSAC, etc.

Furthermore, in an embodiment, the computing system 1000 may estimate a homography matrix based on the corresponding point pairs obtained as described above.

In detail, the computing system 1000 may estimate a homography matrix according to a predetermined corresponding point pair according to [Equation 1] below.

$$[ \begin{matrix}{x}^{′} \\ {y}^{′} \\ 1\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}x \\ y \\ 1\end{matrix} ] \qquad [ Equation 1 ]$$

In particular, the computing system 1000 may transform a first feature coordinate (x, y) to a new feature coordinate (x′, y′) through a homography matrix H in the form of a 3*3 transformation matrix according to a predetermined corresponding point pair.

Therefore, the computing system 1000 may estimate the homography matrix H according to a plurality of corresponding point pairs based on the good product representative image GRI and the inspection target image ITI.

Further, in an embodiment, the computing system 1000 may perform image warping based on the calculated homography matrix H.

In detail, the computing system 1000 may, using the calculated homography matrix H, transform a coordinate system of the inspection target image ITI to match a coordinate system of the good product representative image GRI.

Through this, in an embodiment, the computing system 1000 may align a capturing viewpoint (position) of the inspection target image ITI with a capturing viewpoint (position) of the good product representative image GRI.

Thus, the computing system 1000 may divide an inspection target image aligned based on the good product representative image GRI (hereinafter, referred to as an alignment inspection image AII).

Therefore, the computing system 1000 may effectively prevent performance degradation caused by positional errors that occurs when the target product may not consistently be captured at the same position during acquisition of the inspection target image ITI (for example, when positional variation occurs with each movement due to automated product handling by a machine or similar equipment).

Further, the computing system 1000 according to an embodiment of the present disclosure may divide the aligned inspection target image ITI into patch units (S107).

In general, images used for vision inspection are captured at high resolution to enable detection of even minute defects, so processing the entire image area at once may be inefficient in terms of processing time and resource utilization.

Thus, in an embodiment, the computing system 1000 intends to process a given image (in an embodiment, a good product image and/or an inspection target image ITI, etc.) by dividing the given good product image into predetermined patch units.

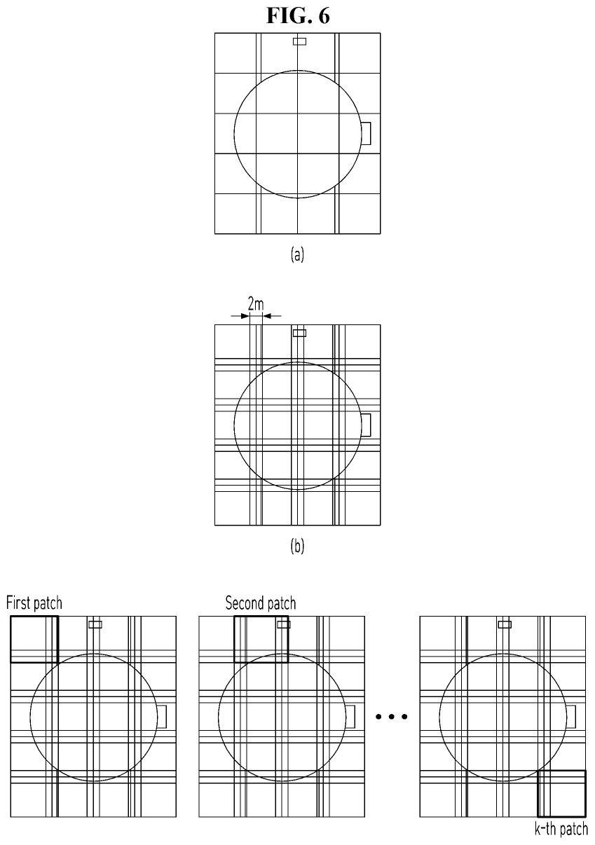

FIG. 6 illustrates examples for describing an image division method in patch units according to an embodiment of the present disclosure.

In detail, referring to FIG. 6, in an embodiment, the computing system 1000 may divide the inspection target image aligned as described above (i.e., the alignment inspection image AII) as described above into patch units of a preset size.

In this case, in an embodiment, the computing system 1000 may divide the image into a plurality of patches having no overlapping areas with each other, as illustrated in (a) of FIG. 6.

As another embodiment, the computing system 1000 may divide the image into a plurality of patches in a form of having an overlapping area of a preset size m (where m>0), as illustrated in (b) of FIG. 6. In such a case, the computing system 1000 may perform computational processing that minimizes errors that may occur at edges between the plurality of patches.

Thus, in an embodiment, the computing system 1000 may divide the alignment inspection image AII into k patches, where k>1, as illustrated in (c) of FIG. 6.

Further, the computing system 1000 according to an embodiment of the present disclosure may obtain a multi-scale feature based on the divided patch (S109).

Here, the multi-scale feature according to the embodiment may mean a feature (feature vector) extracted from an image with different sizes and/or resolutions.

In particular, in an embodiment, the computing system 1000 may implement higher-quality data processing that is robust to scale changes by comprehensively analyzing features extracted at various sizes and/or resolutions based on the divided patch.

In detail, referring further to FIG. 6, in an embodiment, the computing system 1000 may obtain a plurality of patch images by dividing the alignment inspection image AII into patch units (hereinafter, referred to as a plurality of inspection patch images).

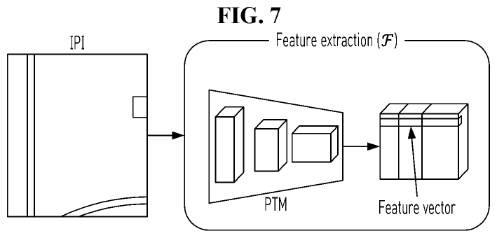

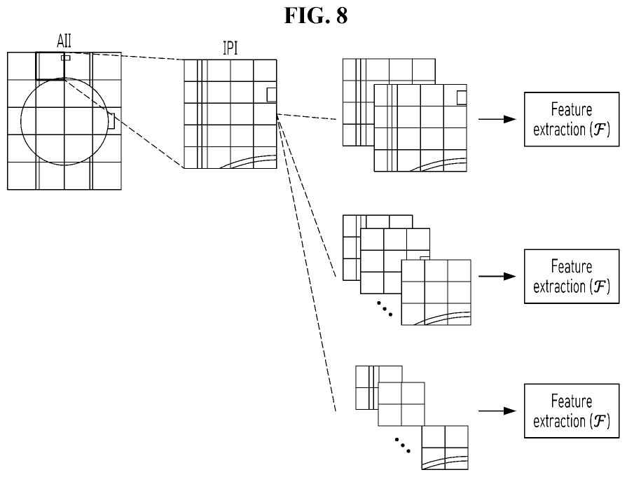

FIG. 7 illustrates a conceptual view for describing a method for extracting image features through a Pre-trained model according to an embodiment of the present disclosure and FIG. 8 illustrates a conceptual view for describing a method for obtaining multi-scale features according to an embodiment of the present disclosure.

Furthermore, referring to FIGS. 7 and 8, in an embodiment, the computing system 1000 may obtain multi-scale features based on the plurality of inspection patch images IPI in conjunction with a model trained through various methodologies such as predetermined deep learning and/or machine learning PTM (hereinafter, referred to as Pre-trained model).

Here, the Pre-trained model PTM according to the embodiment may include a deep learning model pre-trained on a large-scale data set such as ImageNet, or may include a foundation model trained on hundreds of millions of images through self-supervised representation learning. However, these are merely examples, and any deep learning model capable of extracting features from each patch image may be employed.

In another embodiment, the Pre-trained model PTM according to the embodiment may be a deep learning model including algorithms such as a Convolutional Neural Network (CNN) and/or a Transformer.

As such, by utilizing the Pre-trained model PTM, the computing system 1000 may easily perform an image feature extraction process required for the suspected defective area detection service without separate training.

Returning again, with further reference to FIG. 8, in an embodiment, the computing system 1000 may obtain multi-scale features of various sizes and/or resolutions in units of a predetermined inspection patch image IPI.

For example, the computing system 1000 may obtain multi-scale features according to a first size corresponding to one inspection patch image (IPI) size, a second size corresponding to four inspection patch image (IPI) sizes, and a third size corresponding to nine inspection patch image (IPI) sizes.

In this case, according to the embodiment, the computing system 1000 may secondarily divide a predetermined inspection patch image IPI into predetermined sub-patch units.

In an embodiment, a specific method of secondarily dividing the inspection patch image IPI into predetermined sub-patch units is omitted by applying the description of the method of dividing the inspection target image ITI into patch units in step S107 described above.

In addition, in an embodiment, the computing system 1000 may perform multi-scale feature extraction using the above-described Pre-trained model PTM based on the plurality of patch images obtained by performing the second division (hereinafter, referred to as the plurality of sub-patch images).

In particular, the computing system 1000 may divide the given patch image itself into sections in order to consider more detailed features and obtain multi-scale features based thereon.

As such, in an embodiment, the computing system 1000 may extract features according to various scales from the plurality of patch images rather than simply extracting features based on one size.

Thus, the computing system 1000 may extract more detailed features from the image, encompassing complex patterns in a wide area to fine patterns in a small area.

Further, the computing system 1000 according to an embodiment of the present disclosure may estimate a good product probability for each patch image based on the obtained multi-scale features (S111).

Here, the good product probability according to the embodiment may mean a value quantified through Gaussian density estimation of how similar each patch of the inspection target image ITI is to a feature of the good product image.

In particular, in an embodiment, the computing system 1000 may, using the multi-scale feature obtained in step S109 (i.e., a feature vector based on the patches of the alignment inspection image AII), calculate, as a probability, how similar the feature of the alignment inspection image AII is to the feature of the good product image.

In detail, in an embodiment, the computing system 1000 may calculate a good product probability p(x) of each patch image according to a Gaussian density estimation formula such as [Equation 2] below.

$$p ( x ) = \frac{1}{{( 2 π )}^{d / 2} {\vert \sum \vert}^{1 / 2}} exp [ \frac{1}{2} {( x - μ )}^{T} {\sum }^{- 1} ( x - μ ) ] \qquad [ Equation 2 ]$$

Here, in [Equation 2], ‘x’ may mean a feature vector of the corresponding patch, ‘μ’ may mean a mean of the feature vectors extracted from the good product image, ‘Σ′’ may mean a covariance matrix of good product image feature vectors, and ‘d’ may mean a dimension of the feature vector.

In more detail, in an embodiment, the computing system 1000 may, according to [Equation 3] below, obtain the mean u of the feature vectors extracted from N (N>1) good product images.

$$μ = \frac{1}{N} {\sum }_{x , ∈ {X}^{*}} {x}_{i} \qquad [ Equation 3 ]$$

Here, ‘N’ in [Equation 3] means the number of good product images used, and ‘X+’ may mean a good product image.

Further, in an embodiment, the computing system 1000 may, according to [Equation 4] below, obtain the covariance Σ of the feature vectors extracted from N (N>1) good product images.

$$\sum = \frac{1}{N} {\sum }_{x , ∈ {X}^{*}} ( {x}_{i} - μ ) {( {x}_{i} - μ )}^{T} \qquad [ Equation 4 ]$$

In detail, in an embodiment, the computing system 1000 may obtain the multi-scale features for each good product image by applying the process according to steps S105 to S109 described above based on each good image.

In addition, the computing system 1000 may obtain the above-described mean u based on the obtained multi-scale feature for each good-quality image and [Equation 3].

Further, the computing system 1000 may obtain the above-described covariance Σ based on the obtained multi-scale feature for each good product image and [Equation 4].

Furthermore, in an embodiment, the computing system 1000 may apply the mean u and covariance Σ obtained as above to [Equation 2] described above to calculate the good product probability p(x) for each patch image (i.e., each patch image of the alignment inspection image AII) based on Gaussian density estimation.

Thus, the computing system 1000 may estimate how similar the feature for each patch of the inspection target image ITI (here, the alignment inspection image AII) is to the mean feature according to N good product images.

Further, the computing system 1000 according to an embodiment of the present disclosure may determine whether the inspection target image ITI is suspected to be defective based on the estimated good product probability p(x) (S113).

In detail, in an embodiment, the computing system 1000 may compare the good product probability p(x) for each patch image with a predetermined threshold (hereinafter, referred to as classification threshold).

In addition, the computing system 1000 may determine each patch image as a good product patch image or a suspected defective patch image according to a comparison result.

In more detail, in an embodiment, the computing system 1000 may compare the good product probability p(x) for each patch image with a preset first classification threshold.

In this case, the computing system 1000 may determine, when a predetermined good product probability p(x) is equal to or greater than the preset first classification threshold, a patch image corresponding to the predetermined good product probability p(x) is a good product patch image.

Conversely, the computing system 1000 may determine, when the predetermined good product probability p(x) is less than the preset first classification threshold, a patch image corresponding to the predetermined good product probability p(x) to be a suspected defective patch image.

In particular, in an embodiment, the computing system 1000 may determine whether each patch unit of an image is a good product or is suspected to be defective.

Therefore, the computing system 1000 may detect a suspected defective area more quickly and efficiently than by processing an entire image at once, and may analyze each region within the image individually to more precisely detect a specific area where a defect occurs, thereby improving accuracy thereof.

In this case, according to the embodiment, the computing system 1000 may obtain a good product probability p(x) for each of a plurality of sub-patch images corresponding to a predetermined first patch image by applying the description of step S111 described above.

In addition, the computing system 1000 may detect a good product probability p(x) having a minimum value among the obtained good probability p(x) for each of the plurality of sub-patch images (hereinafter, referred to as a minimum good product probability value).

Further, the computing system 1000 may compare the detected minimum good product probability value with the preset first classification threshold.

In this case, the computing system 1000 may determine that, when the minimum good product probability value is equal to or greater than the preset first classification threshold, a first patch image corresponding to the corresponding minimum good product probability value is a good product patch image.

On the other hand, the computing system 1000 may determine that, when the minimum good product probability value is smaller than the preset first classification threshold, the patch image corresponding to the corresponding minimum good product probability value is a suspected defective patch image.

In particular, according to the embodiment, the computing system 1000 determines whether each patch image corresponds to a good product or is suspected to be defective based on a good product probability p(x) derived from the multi-scale feature, which are analyzed in greater detail to further improve detection accuracy.

Meanwhile, according to the embodiment, the computing system 1000 may determine each patch image as the good product patch image or the suspected defective patch image based on a multi-stage classification based on a plurality of preset thresholds (hereinafter, referred to as a plurality of classification thresholds).

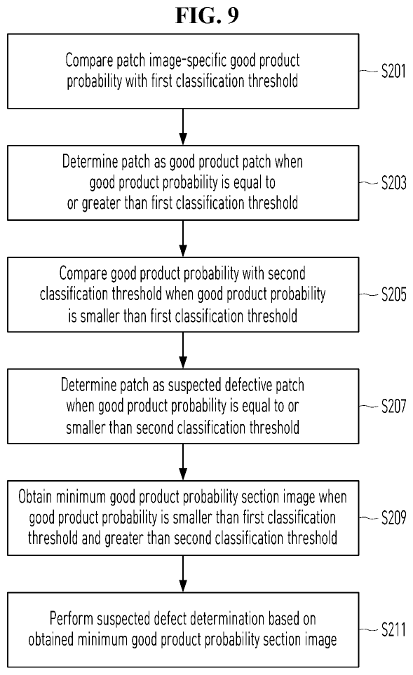

FIG. 9 illustrates a flowchart for describing a multi-stage classification method for patch images for each good product probability p(x) according to an embodiment of the present disclosure.

In detail, referring to FIG. 9, in an embodiment, the computing system 1000 may compare the good product probability p(x) for each patch image with the preset first classification threshold (S201).

Here, the first classification threshold according to the embodiment may correspond to a minimum probability condition for classification as the good product patch image.

Furthermore, the computing system 1000 may determine, when a predetermined good product probability p(x) is equal to or greater than the preset first classification threshold, a patch image corresponding to the predetermined good product probability p(x) as the good product patch image (S203).

On the other hand, the computing system 1000 may set, when the predetermined good product probability p(x) is smaller than the preset first classification threshold, the patch image corresponding to the predetermined good product probability p(x) as a suspected defective candidate patch image.

Further, the computing system 1000 may compare the set good product probability p(x) of the suspected defective candidate patch image (a good product probability p(x) smaller than the preset first classification threshold p(x)) (hereinafter, referred to as a suspected defective candidate probability) with a preset second classification threshold (S205).

Here, the second classification threshold according to the embodiment may correspond to a maximum probability condition for classification as a defective patch image.

Furthermore, the computing system 1000 may determine, when the defective candidate probability is smaller than the preset second classification threshold, a patch image corresponding to the corresponding defective candidate probability as the defective patch image (S207).

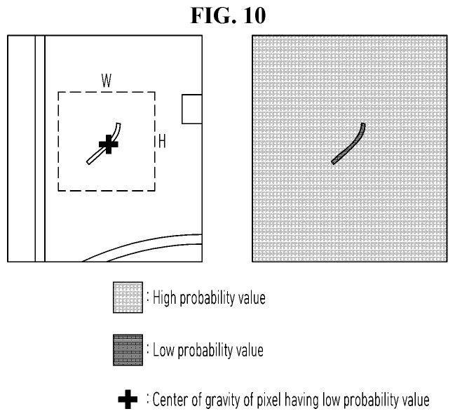

FIG. 10 illustrates an example of a diagram for describing a method for obtaining a minimum good product probability section image according to an embodiment of the present disclosure.

On the other hand, referring to FIG. 10, in an embodiment, when the suspected defective candidate probability is greater than the preset second classification threshold (i.e., when a predetermined good product probability p(x) is smaller than the first classification threshold and greater than the second classification threshold), the computing system 1000 may obtain a good product probability p(x) for each of a plurality of sub-patch images associated with the patch image corresponding to the corresponding suspected defective candidate probability by applying the operations described above with respect to step S111.

In addition, the computing system 1000 may identify a good product probability p(x) having a minimum value among the obtained good product probabilities p(x) for each of the plurality of sub-patch images (hereinafter, referred to as a minimum good product probability value).

In addition, in an embodiment, the computing system 1000 may extract an area having a predetermined size (H (Height)*W (Width)) centered on an area matching the detected minimum good product probability value (hereinafter, referred to as a minimum good product probability point).

In this case, in an embodiment, when there is one minimum good product probability point (in an embodiment, a pixel having a minimum good product probability value), the computing system 1000 may extract an area having a predetermined size centered on the minimum good product probability point).

On the other hand, referring further to FIG. 10, when a plurality of minimum good product probability points are present, the computing system 1000 may calculate a center of gravity corresponding to positions of the plurality of corresponding minimum good product probability points.

In an embodiment of the present disclosure, a specific method by which the computing system 1000 calculates the above-described center of gravity may be implemented utilizing any of various known algorithms capable of performing such a calculation. However, the embodiment of the present disclosure is not limited to any particular algorithm, and the algorithmic approach itself is not restricted.

Further, in an embodiment, the computing system 1000 may extract an area having a predetermined size around an area corresponding to the calculated center of gravity (hereinafter, referred to as a center of gravity point).

In particular, the computing system 1000 may extract an area having a predetermined size (hereinafter, referred to as a minimum good product probability section) centered on a pixel having a lowest probability value among the good product probabilities p(x) for each of the plurality of sub-patch images or the center of gravity of the pixels.

Thus, in an embodiment, the computing system 1000 may obtain an image including the extracted minimum good product probability section (hereinafter, referred to as a minimum good product probability section image) (S209).

Furthermore, in an embodiment, the computing system 1000 may, in conjunction with a model trained through various methodologies such as predetermined deep learning and/or machine learning (i.e., a Pre-trained model PTM), perform a determination of good product or defect suspicion for each patch image of the minimum good product probability section image obtained as above (S211).

In other words, the computing system 1000 may determine, in conjunction with a predetermined Pre-trained model PTM, each patch image of the minimum good product probability section image as the good product patch image or the suspected defective patch image.

Here, the Pre-trained model PTM according to the embodiment may include a deep learning classification model trained on a relevant data set. The Pre-trained model PTM may also include a model that applies a machine learning methodology such as Random Forest after extracting a feature value from an image using a predetermined image processing technique. Accordingly, various alternative embodiments may be employed.

As described above, in an embodiment, the computing system 1000 may immediately determine patch samples having a high probability of being the good product equal to or greater than a predetermined threshold as good products. Likewise, patch samples having a low probability of being the good product equal to or smaller than the predetermined threshold may be rapidly classified as suspected defective patches, thereby reducing an overall processing time.

In addition, the computing system 1000 may, for patch samples in an intermediate state where it is ambiguous whether the patch samples are good products or are suspected to be defective, crop an image centered on an area with a lowest probability of being the good product (i.e., an area with a highest probability of defect occurrence) and perform a re-inspection process based thereon to additionally determine whether the patch samples are suspected to be defective.

Through the multi-stage determination method, the computing system 1000 may significantly improve the efficiency and accuracy of suspected defective area detection by minimizing misjudgments that may occur in uncertain areas while maintaining a processing speed in the inspection process.

Referring back to FIG. 4, the computing system 1000 that determines each patch image as the good product patch image or the suspected defective patch image may determine whether the corresponding inspection target image ITI is suspected to be defective according to a predetermined method.

In an embodiment, the computing system 1000 may determine whether the inspection target image ITI is suspected to be defective based on the number of good patch images (hereinafter, referred to as the number of good patches) and the number of suspected defective patch images (hereinafter, referred to as the number of suspected defective patches).

For example, the computing system 1000 may calculate a ratio between the number of good product patches and the number of suspected defective patches, and detect which side has a higher calculated ratio.

In this case, the computing system 1000 may determine that the inspection target image ITI is the good product image when the ratio of the number of good product patches is higher.

On the other hand, the computing system 1000 may determine that the inspection target image ITI is the suspected defective image when the ratio of the number of suspected defective patches is higher.

As another example, the computing system 1000 may determine that the inspection target image ITI is the good product image when the number of good product patches is equal to or greater than a predetermined reference value, or determine that the inspection target image ITI is the suspected defective image when the number of suspected defective patches is equal to or greater than a predetermined reference value.

As described above, the computing system 1000 according to the embodiment of the present disclosure may efficiently detect suspected defective areas within the inspection target image ITI through patch-level good product probability p(x) estimation using a small number of good product images without separate pre-training.

Through this, the computing system 1000 may quickly and accurately detect the suspected defective areas through advanced analysis using a deep learning model.

In particular, the computing system 1000 may flexibly adapt to a variety of products and/or inspection environment changes without going through a separate training process, while reducing a burden of data collection for model learning by using a Pre-trained model.

Further, the computing system 1000 may save a time and resources required for vision inspection by dividing and processing the image at a patch level compared to a method of processing an entire area of the image in a batch.

Thus, the computing system 1000 may implement a suspected defective area detection service maintaining high accuracy while maximizing the speed and efficiency of the vision inspection process.

Further, the computing system 1000 according to an embodiment of the present disclosure may provide a suspected defect determination result (S115).

In particular, in an embodiment, the computing system 1000 may provide a determination result of a suspected defect for the inspection target image ITI (i.e., a result of determining whether the inspection target image ITI is the good product image or the suspected defective image) according to a predetermined method.

In an embodiment, the computing system 1000 may provide a suspected defect determination result, as determined according to the embodiment of the present disclosure, in conjunction with a predetermined application service. Examples of such services may include a part inspection service, a semiconductor wafer inspection service, a food packaging inspection service, and/or a smart phone manufacturing inspection service.

As described above, the suspected defective area detection method and the system thereof according to an embodiment of the present disclosure may detect a suspected defective area through a deep learning-based Pre-trained model PTM without separate training by utilizing a small number of good product images. This may provide the advantage of reducing the data collection burden typically associated with training and enables flexible adaptation to changes in inspection environments.

In addition, the suspected defective area detection method and the system thereof according to an embodiment of the present disclosure has an effect of reducing time and resources required for inspection compared to a method of batch processing an entire region of an image by dividing and processing the image at a patch level.

Meanwhile, the embodiments according to the present disclosure described above may be implemented in a form of a program command which may be executed through various computer components means and recorded in the computer readable recording medium. The computer readable recording medium may include singly a program command, a data file, or a data structure or a combination thereof. The program instruction recorded in the computer readable recording medium may be specially designed and configured for the present disclosure, or may be publicly known to and used by those skilled in the computer software field. Examples of the computer readable recording media may include a hardware device particularly configured to store and execute program instructions, magnetic media such as hard disks, floppy disks, and magnetic tape, optical recording media such as CD-ROM disks and DVD, magneto-optical media such as floptical disks, ROM, RAM, and flash memories. Examples of the program instructions include a high-level language code executable by a computer by using an interpreter, and the like, as well as a machine language code created by a compiler. The hardware devices may be changed to one or more software modules in order to perform the processing according to the present disclosure, and an opposite situation thereof is available.

Specific executions described in the present disclosure are embodiments and the scope of the present disclosure is not limited even by any method. For brevity of the specification, descriptions of conventional electronic configurations, control systems, software, and other functional aspects of the systems may be omitted. Further, connection or connection members of lines among components represent functions connections and/or physical or circuitry connections and may be represented as various functional connections, physical connections, or circuitry connections which are replaceable or added in an actual device. Further, unless otherwise specified, such as “essential”, “important”, etc., the connections may not be components particularly required for application of the present disclosure.

Further, in the detailed description of the present disclosure, which is described, while the present disclosure has been described with respect to the preferred embodiments, it will be understood by those skilled in the art or those skilled in the art having ordinary knowledge in the technical field that various changes and modifications of the present disclosure may be made without departing from the spirit and the technical scope of the present disclosure disclosed in the following claims. Accordingly, the technical scope of the present disclosure should not be limited to the contents disclosed in the detailed description of the specification but should be defined only by the claims.

The present disclosure relates to a suspected defective area detection method and a system thereof, and has an industrial applicability as the present disclosure can be used in an artificial intelligence industry.

Meanwhile, a system for detecting a suspected defective area according to an embodiment of the present disclosure includes: at least one memory; and at least one processor reading at least one application stored in the memory and detecting a suspected defective area, and instructions of the processor include instructions of performing obtaining N (N>1) good product images, obtaining an inspection target image which is a captured image of a target to be determined to be defective, aligning the inspection target image based on the good product image, dividing the aligned inspection target image into patch units, obtaining multi-scale features based on the divided patches by using a predetermined Pre-trained model, estimating the patch-specific good product probability based on the obtained multi-scale features, determining whether the inspection target image is suspected to be defective based on the estimated patch-specific good product probability and providing the determination result of whether the inspection target image being suspected to be defective.

The suspected defective area detection method and the system thereof according to an embodiment of the present disclosure detect a suspected defective region through a deep learning-based pre-trained model without separate training by using a small number of good product images, thereby having an effect of reducing the data collection burden for model training and flexibly coping with changes in inspection environments.

In addition, the suspected defective area detection method and the system thereof according to an embodiment of the present disclosure has an effect of reducing time and resources required for inspection compared to a method of batch processing an entire region of an image by dividing and processing the image at a patch level.

Accordingly, the suspected defective area detection method and the system thereof according to an embodiment of the present disclosure have effects of being usefully applied to a multi-variety low-volume production environment and simultaneously improving inspection accuracy and efficiency.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A method executed by a computer, the method comprising:
loading, by at least one processor, at least one image, the at least one image including N good product images, where N>1, and at least one inspection target image including a captured image of a target to be evaluated for a defect;
aligning, by the at least one processor, the at least one inspection target image based on the loaded N good product images;
dividing, by the at least one processor, the aligned at least one inspection target image into at least one patch unit;
ingesting, by the at least one processor, the at least one divided patch unit into at least one artificial intelligence model and obtaining multi-scale features based on the divided patch units, wherein the artificial intelligence model includes a deep learning model pre-trained on a large-scale image data set;
estimating, by the at least one processor, the patch-specific good product probability based on the obtained multi-scale features;
determining, by the at least one processor, whether the inspection target image is suspected to be defective based on the estimated patch-specific good product probability; and
manifesting, by the at least one processor, a determination result indicating whether the inspection target image is suspected to be defective through at least one interface.

2. The method of claim 1, wherein the multi-scale features include data extracted from a feature vector for a predetermined image based on various sizes or resolutions.

3. The method of claim 2, wherein the obtaining of the multi-scale features includes generating the size in the patch unit and obtaining the multi-scale features.

4. The method of claim 1, wherein the estimating of the patch-specific good product probability includes:
calculating a similarity between a feature vector of each of the patches and a feature vector of a good product image based on Gaussian density estimation.

5. The method of claim 4, wherein the calculating of the similarity includes:
calculating a mean and a covariance of the feature vectors of the good product image, and
calculating the similarity based on the calculated mean and covariance and the feature vector of each of the patches.

6. The method of claim 1, wherein the determining of whether the inspection target image is suspected to be defective includes:
comparing each of the patch-specific good product probabilities with a predetermined first threshold; and
determining each patch as a good product patch or a suspected defective patch based on a result of the comparison.

7. The method of claim 1, wherein the determining of whether the inspection target image is suspected to be defective includes:
comparing each of the patch-specific good product probabilities with a predetermined second threshold:
determining a patch having a good product probability equal to or greater than the second threshold as the good product patch, and comparing a good product probability which is smaller than the second threshold with a predetermined third threshold; and
determining a patch having a good product probability equal to or smaller than the third threshold as a suspected defective patch.

8. The method of claim 7, wherein the determining of whether the inspection target image is suspected to be defective further includes:
obtaining a plurality of sub-patches based on a patch having a good product probability which is smaller than the second threshold and greater than the third threshold;
calculating a minimum good product probability value corresponding to a lowest good product probability among the good product probabilities of the plurality of sub-patches;
extracting an area having a predetermined size based on an area matching the obtained minimum good product probability value; and
determining whether the inspection target image is suspected to be defective based on an image including the extracted area.

9. The method of claim 8, wherein the determining of whether the inspection target image is suspected to be defective further includes:
in response to a plurality of minimum good product probability values being present, calculating a center of gravity corresponding to positions of areas associated with the plurality of minimum good product probability values;
extracting an area having a predetermined size based on an area corresponding to the calculated center of gravity; and
determining whether the inspection target image is suspected to be defective based on an image including the extracted area.

10. The method of claim 1, wherein the determining of whether the inspection target image is suspected to be defective further includes:
comparing each of the patch-specific good product probabilities with at least one predetermined threshold;
classifying each patch as a good product patch or a suspected defective patch based on a result of the comparison; and
determining whether the inspection target image is suspected to be defective based on the number of patches classified as at least one of the good product patch or the suspected defective patch.

11. The method of claim 1, wherein the aligning of the inspection target image based on the good product image includes:
selecting any one of the N good product images, where N>1, as a good product representative image;
detecting features of each of the good product representative image and the inspection target image;
matching corresponding features between the features detected from the good-product representative image and the inspection target image;
estimating a homography matrix based on the matched features; and
performing image warping on the inspection target image based on the estimated homography matrix.

12. A system comprising:
at least one memory; and
at least one processor configured to read at least one application stored in the at least one memory and to detect a suspected defective area,
wherein the at least one processor is configured to execute instructions that cause the system to perform:
loading, by the at least one processor, at least one image stored in the at least one memory, wherein the at least one image includes N good product images, where N>1, and at least one inspection target image which is a captured image of a target to be evaluated for a defect;
aligning, by the at least one processor, the inspection target image based on the loaded good product image;
dividing, by the at least one processor, the aligned inspection target image into at least one patch unit;
inputting, by the at least one processor, the at least one divided patch unit into at least one artificial intelligence model, and obtaining multi-scale features based on the divided patch units, the artificial intelligence model including a deep learning model pre-trained on a large-scale image data set;
estimating, by the at least one processor, a patch-specific good product probability based on the obtained multi-scale features;
determining, by the at least one processor, whether the inspection target image is suspected to be defective based on the estimated patch-specific good product probability; and
outputting, by the at least one processor, a result indicating whether the inspection target image is suspected to be defective through at least one interface.

13. A system comprising:
at least one memory; and
at least one processor configured to execute instructions stored in the at least one memory,
wherein the instructions, when executed, cause the at least one processor to:
obtain a plurality of good product images and an inspection target image;
perform alignment of the inspection target image with respect to at least one of the good product images;
partition the aligned inspection target image into a plurality of regions;
process the regions using an artificial intelligence model to generate feature information for the regions;
derive, for each region, a probability value indicative of whether the region corresponds to a good product region;
evaluate the inspection target image for a potential defect based on the probability values; and
output information indicating whether the inspection target image is suspected to be defective.

14. The system of claim 13, wherein the multi-scale features include data extracted from a feature vector for a predetermined image based on various sizes or resolutions.

15. The system of claim 13, wherein the obtaining of the multi-scale features includes
generating the size in the patch unit and obtaining the multi-scale features.

16. The system of claim 13, wherein the estimating of the patch-specific good product probability includes:
calculating a similarity between a feature vector of each of the patches and a feature vector of a good product image based on Gaussian density estimation, and
wherein the Gaussian density estimation formula is,
$$p ( x ) = \frac{1}{{( 2 π )}^{d / 2} {\vert \sum \vert}^{1 / 2}} exp [ \frac{1}{2} {( x - μ )}^{T} {\sum }^{- 1} ( x - μ ) ] ,$$
where ‘x’ is a feature vector of the corresponding patch, ‘μ’ is a mean of the feature vectors extracted from the good product image, ‘Σ′’ is a covariance matrix of good product image feature vectors, and ‘d’ is a dimension of the feature vector.

17. The system of claim 13, wherein the determining of whether the inspection target image is suspected to be defective includes:
comparing each of the patch-specific good product probabilities with a predetermined first threshold; and
determining each patch as a good product patch or a suspected defective patch based on a result of the comparison.

18. The system of claim 13, wherein the determining of whether the inspection target image is suspected to be defective includes:
comparing each of the patch-specific good product probabilities with a predetermined second threshold:
determining a patch having a good product probability equal to or greater than the second threshold as the good product patch, and comparing a good product probability which is smaller than the second threshold with a predetermined third threshold; and
determining a patch having a good product probability equal to or smaller than the third threshold as a suspected defective patch.

19. The system of claim 18, wherein the determining of whether the inspection target image is suspected to be defective further includes:
obtaining a plurality of sub-patches based on a patch having a good product probability which is smaller than the second threshold and greater than the third threshold;
calculating a minimum good product probability value corresponding to a lowest good product probability among the good product probabilities of the plurality of sub-patches;
extracting an area having a predetermined size based on an area matching the obtained minimum good product probability value; and
determining whether the inspection target image is suspected to be defective based on an image including the extracted area.

20. The system of claim 13, wherein the determining of whether the inspection target image is suspected to be defective further includes:
comparing each of the patch-specific good product probabilities with at least one predetermined threshold;
classifying each patch as a good product patch or a suspected defective patch based on a result of the comparison; and
determining whether the inspection target image is suspected to be defective based on the number of patches classified as at least one of the good product patch or the suspected defective patch.
